(19) United States
(12) Patent Application Publication
(10) Pub. No.: US 2012/0163165 A1
(43) Pub. Date: Jun. 28, 2012

(54) APPARATUS AND METHOD FOR PACKET TRANSPORT SERVICE BASED ON MULTI PROTOCOL LABEL SWITCHING-TRANSPORT PROFILE (MPLS-TP) NETWORK

(75) Inventors: Yong-Wook RA, Daejeon-si (KR); Tae-Sik CHEUNG, Daejeon-si (KR); Chang-Ho CHOI, Daejeon-si (KR); Tae-Kyu KANG, Daejeon-si (KR)

(73) Assignee: Electronics and Telecommunications Research Institute, Daejeon-si (KR)

(21) Appl. No.: 13/334,721

(22) Filed: Dec. 22, 2011

(30) Foreign Application Priority Data
Dec. 23, 2010 (KR) 10-2010-0133823
Apr. 20, 2011 (KR) 10-2011-0036899

(51) Int. Cl. H04L 12/56; H04L 12/26

(52) U.S. Cl. 370/225; 370/392; 370/235; 370/390

(57) ABSTRACT

There is provided a packet processing apparatus for transmitting packets received from a plurality of networks through a Label Switched Path (LSP), the packet processing apparatus including: a packet classifier to classify a received packet to a control packet or a normal packet based on port information included in field information of the received packet, and to decide, if the received packet is a normal packet, a service type for transmitting the normal packet according to whether the normal packet is a reception packet or a transmission packet; and a packet processor to acquire LSP condition information or address information from the field information of the normal packet, and to transmit the received packet and update the header or address information of the received packet, according to the service type decided by the packet classifier, with reference to the LSP condition information or the address information.

### CROSS-REFERENCE TO RELATED APPLICATION

This application claims the benefit under 35 U.S.C. §119(a) of a Korean Patent Applications No. 10-2010-0133823, filed on Dec. 23, 2010, and No. 10-2011-0036899, filed on Apr. 20, 2011, the entire disclosures of which are incorporated herein by reference for all purposes.

### BACKGROUND

1. Field

The following description relates to a packet processing apparatus and method for guaranteeing end-to-end Quality of Service (QoS) through a Multi Protocol Label Switching-Transport Profile (MPLS-TP) network and transmitting reliable packets.

2. Description of the Related Art

Packet transport services are generally based on point-to-point connection services using Time-Division Multiplexing (TDM) through a Synchronous Optical Network (SONET) or Synchronous Digital Hierarchy (SDH). However, since the transport service has a limitation in transmission rate, it shows low flexibility in accepting new business models due to a cost load for capacity increase, etc. Meanwhile, an IP-based transport service has a relatively lower cost load for capacity increase than the SONET or SDH network, while requiring critical Service-Level Agreements (SLA) for guaranteeing end-to-end Quality of Service (QoS).

Accordingly, Internet Engineering Task Force (IETF) has been conducted studies into a transport service capable of providing extensibility and guaranteeing end-to-end QoS using standard data-link layers, such as Multi Protocol Label Switching-Transport Profile (MPLS-TP), IEEE802.1ah (PBB), and IEEE802.1ag (PBB-TE). Here, “MPLS-TP” was newly named by IETF being presently standardizing T-MPLS which has been being standardized by International Telecommunication Union-Telecommunication standardization sector (ITU-T). The MPLS-TP applies requirements for a transport network to the IETF MPLS based on conventional MPLS and PWE3 architectures to extend forwarding of IETF MPLS, OAM, survivability, network management, and a control plane protocol, thereby performing standardization. Also, the MPLS-TP proposes factors to satisfy transmission requirements for the conventional MPLS before RFC5654, and additional functions based on new transmission requirements, and particularly, proposes functions, such as transport-like OAM, transport-like resilience, transport-like operation, etc., for fault recovery and reliability improvement.

### SUMMARY

The following description relates to provision of functions, such as path management, protection switching, Quality of Service (QoS), management of statistics, connection acceptance control, system management, etc., for each service, by creating and managing services and processing packets for each service based on data link layer information upon providing PWE3 services in a MPLS-TP network, a customer network, a provider bridge network, or a MPLS network.

The following description also relates to a method of processing packets in the same manner without distinguishing Ingress Provider Edge (PE) nodes, Transit P nodes, Egress PE nodes, etc.

The following description also relates to provision of a stacking function having no limitation in number of MPLS-TP layer stacks and label stacks in order to remove limitation in hierarchical structure of a network configuration.

In one general aspect, there is provided a packet processing apparatus located in a Multi Protocol Label Switching-Transport Profile (MPLS-TP) network to transmit packets received from a plurality of networks through a Label Switched Path (LSP), the packet processing apparatus including: a packet classifier configured to classify a received packet to a control packet or a normal packet based on port information included in field information of the received packet, the field information extracted according to control information of a control register, and to decide, if the received packet is a normal packet, a service type for transmitting the normal packet according to whether the normal packet is a reception packet or a transmission packet; and a packet processor configured to acquire LSP condition information or address information from the field information of the normal packet, and to transmit the received packet and update the header or address information of the received packet, according to the service type decided by the packet classifier, with reference to the LSP condition information or the address information.

The packet classifier transmits, if the received packet is a control packet, the control packet to a upper control channel through a CPU interface, and the packet processor includes: a reception packet processor configured to create, if the received packet is a reception packet, a service type related to the reception packet, and to acquire LSP condition information from a table related to the created service type; and a transmission packet processor configured to acquire, if the received packet is a transmission packet, LSP transmission information or address information for transmitting the transmission packet through the LPS according to whether a destination to which the transmission packet has to be transmitted is a PW end point.

The reception packet processor includes a PW FEC lookup unit configured to combine port information, C-VID information, and S-VID information included in the field information of the reception packet according to the service type decided by the packet classifier and create the decided service type, and to acquire PTL index information and tag control information for extracting LSP information from a PW FEC table.

The reception packet processor includes an IP FEC lookup unit configured to combine port information, C-VID information, a source MAC address, and E-type information included in the field information of the reception packet to create the decided service type, and to acquire PTL index information for extracting LSP information, a control flag for controlling ELSP, and ELSP label information from an IP FEC table database.

The reception packet processor includes a MPLS label lookup unit configured to create the decided service type using port information and MPLS label information included in the field information of the received packet, and to acquire PTL index information for extracting LSP information, a SDT, a new tag, MPLS control information, and tag control information for other control, from a MPLS ILM table database.

Accordingly, the reception packet processor combines port information, C-VID, S-VID, a source MAC address, E-type information, and MPLS label information, which are included in the field information of a packet received through a plurality of local networks, a provider bridge network, and a MPLS network, thereby creating a service type and acquiring LSP condition information including PTL index information for extracting LSP information.

The reception packet processor includes: a first NHLFE lookup unit configured to decide a service type created by at least one lookup unit according to whether information acquired by the corresponding lookup unit is identical to pre-stored information, and to acquire a switch fabric and a transmission/reception output port for transmitting the reception packet through the LSP, a tag value, a TM queue index, a TB profile, a packet counter, and tag control information for other control, from an index table; and a second NHLFE lookup unit configured to acquire a SLSP label, a plurality of TLSP labels, EXP, Stack, TTL, next PTL index information, D-MAC (Destination-MAC) or M-ID, and label control information, related to a MPLS-TP layer, from a service table.

The packet processor further includes: a PTL lookup unit configured to acquire token bucket profile information and a token bucket index for policing and shaping to guarantee QoS, from a PTL table database; and a Hash/TB counter lookup unit configured to decide to transmit the reception packet according to the created service type or a temporary service type stored in a hash table, based on whether the SLSP label acquired by the second NHLFE lookup unit is identical to a SLSP label stored in the service table database, wherein the Hash/TB counter lookup unit updates, if the SLSP label acquired by the second NHLFE lookup unit is identical to the SLSP label stored in the service table database, a service type stored in the hash table to the created service type, updates, if the SLSP label acquired by the second NHLFE lookup unit is not identical to the SLSP label stored in the service table database, a Hash table database by adding new Hash entries through learning of information acquired from the PTL table database, and decides whether or not to transmit the reception packet in an order of color-marked packets through metering according to whether a bandwidth required by the service type exceeds a threshold value stored in a TB counter table database.

Accordingly, it is possible to determine whether to transmit a reception packet according to a service type created by at least one lookup unit among the PW FEC lookup unit, the IP FEC lookup unit, and the MPLS label lookup unit, and to determine whether to transmit the reception packet according to the service type based on a bandwidth profile (CIR-Committed Information Rate, EIR-Excess Information Rate) of the service type.

The packet processor includes: a traffic management unit configured to terminate transmitting the reception packet according to a QoS profile established through the CPU interface from the upper control channel, according to the decision on whether or not to transmit the reception packet by the Hash/TB counter lookup unit; a header creator configured to create three internal headers based on information acquired by the first and second NHLFE lookup units; and a header processor configured to perform encapsulation and decapsulation of TLSP and SLSP labels related to the MPLS-TP layer through a Push, Swap, or Pop function, to perform encapsulation of the three internal headers acquired by the header creator, and to insert/remove/change VLAN tag information acquired by the first NHLFE lookup unit into/from/in the field information of the reception packet so that the reception packet is optimized for the destination network, in order to transmit the reception packet through the LSP to a destination network.

The packet processor further includes a TTL controller configured to subtract TTL, if a most significant label (TLSP or SLSP) related to the MPLS-TP layer is Swap, to copy the TTL according to a TTL processing mode if the most significant label is Pop, and to initialize the TTL to a TTL value acquired by the second NHLFE lookup unit if the most significant label is Push, and the header processor updates a TTL field of the most significant label related to the MPLS-TP layer according to factor values applied by TTL subtraction, TTL copy, and TTL initialization from the TTL controller 538, and inserts/removes/changes the internal headers created by the header creator into/from/in headers of the reception packet, according to header condition information stored in a packet memory.

The packet processing apparatus further includes: an OAM packet processor configured to determine whether there is an error on a reception path of the classified packet using SLSP OAM, TLSP OAM, and PW OAM stored in an OAM table database; and a path protection-switching unit configured to perform, if there is an error on the reception path of the packet, protection-switching to a path related to the reception path of the packet.

Accordingly, it is possible to insert/remove/change headers, a MPLS-TP label and a L2 VLAN tag into/from/in field information of a reception packet, and also to protection-switch a packet to an available path according to whether there is failure on a path through which the packet is being transmitted.

The transmission packet processor includes: a port lookup unit configured to update, if the transmission packet is no MPLS transmission packet including the internal headers, a source MAC address of an output port written in field information of the transmission packet, and to acquire the source MAC address, a TM queue index, and packet counter index information of the output port from a S-MAC table database; and a port label lookup unit configured to update, if the transmission packet is a MPLS transmission packet including the internal headers, the output port written in the field information of the MPLS transmission packet and updates source MAC addresses of the output port and the most significant label related to the MPLS-TP layer included in the field information of the transmission packet including internal headers, and acquires a source MAC address, a TM queue index, and packet counter index information of the output port from a port-label table database.

The transmission packet processor further includes a multicast lookup unit configured to decide whether to transmit the transmission packet in a multicast manner or in a unicast manner, based on M-ID information and a flag of at least one label included in the extracted field information, and to acquire a D-MAC address, a PTL index, a MPLS-TP layer label, EXPs, STACKs, TTLs, a tag value, a TM queue index, a counter index, and control information, for transmitting the transmission packet through a LSP established in the MPLS-TP network, from a multicast table database.

The transmission packet processor further includes: a PW multicast lookup unit configured to decide whether to transmit the transmission packet in a multicast manner or in a unicast manner, based on M-ID information and a flag of at least one label included in the extracted field information, and to acquire a SDT, a PTL index, a tag value, a TM queue index, and control information for transmitting the transmission packet through a LSP established in the MPLS-TP network, from a PW multicast table database; and a PW decapsulation unit configured to remove PW when a PW terminal flag is enabled.

Therefore, the transmission packet processor may determine whether to transmit a transmission packet in a multicast manner or in a unicast manner, based on output port information, M-ID information, and flag information included in the transmission packet.

Accordingly, it is possible to provide functions, such as path management, protection switching, Quality of Service (QoS), management of statistics, connection acceptance control, system management, etc., for each service, by creating and managing services and processing packets for each service based on data link layer information upon providing PWE3 services in a MPLS-TP network, a customer network, a provider bridge network, or a MPLS network.

Also, it is possible to process packets in the same manner without distinguishing Ingress Provider Edge (PE) nodes, Transit P nodes, Egress PE nodes, etc.

In addition, it is possible to provide a stacking function having no limitation in number of MPLS-TP layer stacks and label stacks in order to remove limitation in hierarchical structure of a network configuration.

Other features and aspects will be apparent from the following detailed description, the drawings, and the claims.

### BRIEF DESCRIPTION OF THE DRAWINGS

FIG. 1 is a diagram illustrating a configuration of a packet transport system including a plurality of packet processing apparatuses.

FIG. 2 is a flowchart illustrating an example of a method in which a packet processing apparatus located in a MPLS-TP network transmits packets received from an external network through a Label Switched Path (LSP).

FIG. 3 is a flowchart illustrating an example of a method in which the packet processing apparatus acquires LSP condition information for extracting LSP information.

FIG. 4 is a flowchart illustrating an example of a method in which the packet processing apparatus located in the MPLS-TP network transmits transmission packets.

FIG. 5 is a diagram illustrating an example of a packet processing apparatus of providing a packet transport service.

FIG. 6 illustrates an example of a service type which the packet processing apparatus provides according to a MPLS-TP standard.

FIG. 7 illustrates examples of control signals that are controlled by a control/management unit of the packet processing apparatus.

FIG. 8 is an exemplary view showing the positions of internal headers included in field information of a transmission packet.

FIG. 9A is a view for explaining an example of a process of providing a packet transport service between customer networks through a LSP established in a MPLS-TP network.

FIG. 9B is a view for explaining an example of a process of providing a packet transport service between provider bridge networks through another LSP established in the MPLS-TP network.

FIG. 10A is a view for explaining an example of a process of providing a packet transport service between MPLS networks through a LSP established in the MPLS-TP network.

FIG. 10B is a view for explaining an example of a process of providing a packet transport service between a provider bridge network and a customer network through another LSP established in the MPLS-TP network.

FIG. 11A is a view for explaining another example of a process of providing a packet transport service between customer networks through a LSP established in the MPLS-TP network.

FIG. 11B is a view for explaining another example of a process of providing a packet transport service between provider bridge networks through another LSP established in the MPLS-TP network.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

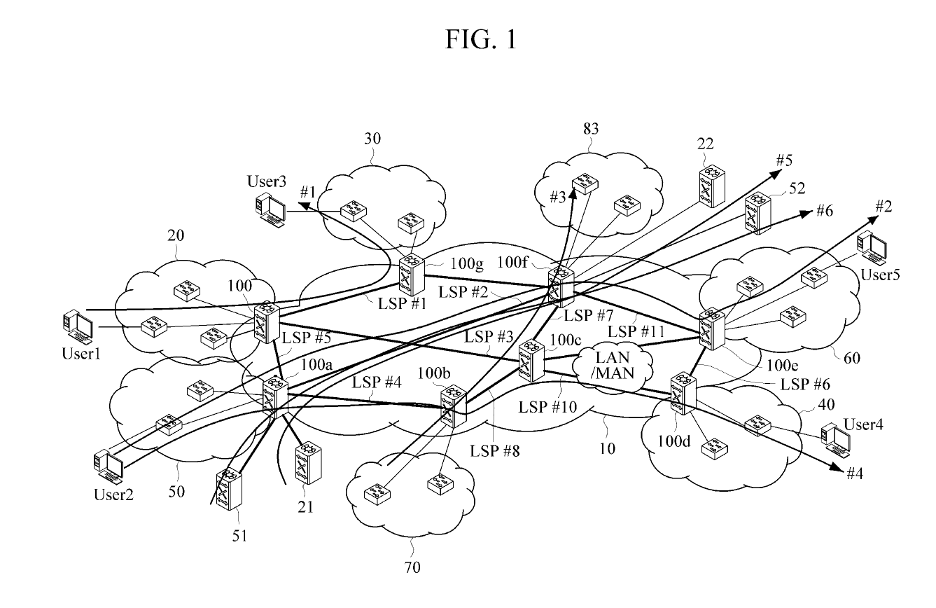

FIG. 1 is a diagram illustrating a configuration of a packet transport system including a plurality of packet processing apparatuses 100a through 100h.

As illustrated in FIG. 1, the packet transport system transmits packets to a plurality of users 1 through 5 who are distributed over a Multi Protocol Label Switching-Transport Profile (MPLS-TP) network 10, a plurality of local networks 20, 30, and 40, provider bridge networks 50 and 60, and MPLS networks 70 and 80. That is, the packet processing apparatuses 100a through 100h located in the MPLS-TP network 10 are physically connected to the users 1 through 5, and transmit packets that are received through a plurality of access switches located in the local networks 20, 30, and 40 or the provider bridge networks 50 and 60 or through a plurality of access switches located in the MPLS networks 70 and 80, to the users 1 through 5. The packet processing apparatuses 100a through 100h may transmit packets received from the local networks 20, 30 and 40, the provider bridge networks 50 and 60, or the MPLS networks 70 and 80 via a Label Switched Path (LSP) created dynamically according to a previously established protocol or a linked protocol, to access switches or customer edges 21, 22, 51 and 52 physically connected to the users 1 through 5, according to a service type.

A method in which the packet processing apparatuses 100a through 100h located in the MPLS-TP network 10 transmits packets received from at least one of local networks, provider bridge networks, and MPLS networks through a LSP is as follows. First, a method in which at least one of the packet processing apparatuses 100a through 100h transmits packets received from at least one of the local networks, provider bridge networks, and MPLS networks will be described in detail below.

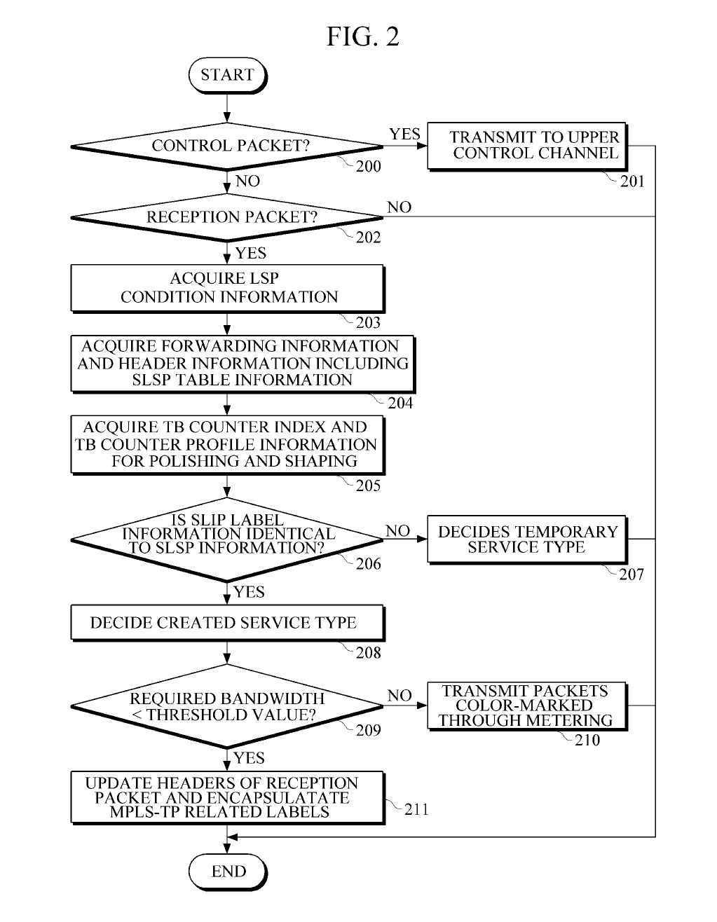

FIG. 2 is a flowchart illustrating an example of a method in which a packet processing apparatus located in a MPLS-TP network transmits packets received from an external network through a LSP.

Referring to FIG. 2, when a packet is received from at least one of a plurality of local networks, provider bridge networks and MPLS networks through a LSP, the packet processing apparatus determines whether the packet is a control packet or a normal packet (200). If the packet is determined to be a control packet, the packet processing apparatus transmits the packet to a upper control channel through a CPU interface (201). Meanwhile, if the packet is determined to be a normal packet, the packet processing apparatus determines whether the packet is a reception packet (202). If the packet is determined to be a reception packet, the packet processing apparatus decides a service type for transporting the reception packet according to a type of the reception packet. Then, the packet processing apparatus creates the decided service type using at least one piece of information among Ethernet header information, field information, MPLS label information included in the reception packet, and acquires LSP condition information for extracting LSP information according to the created service type (203). Meanwhile, the operation of the packet processing apparatus when the packet is determined to be a transmission packet will be described in detail later, and a method of acquiring LSP condition information for extracting LSP information is described below.

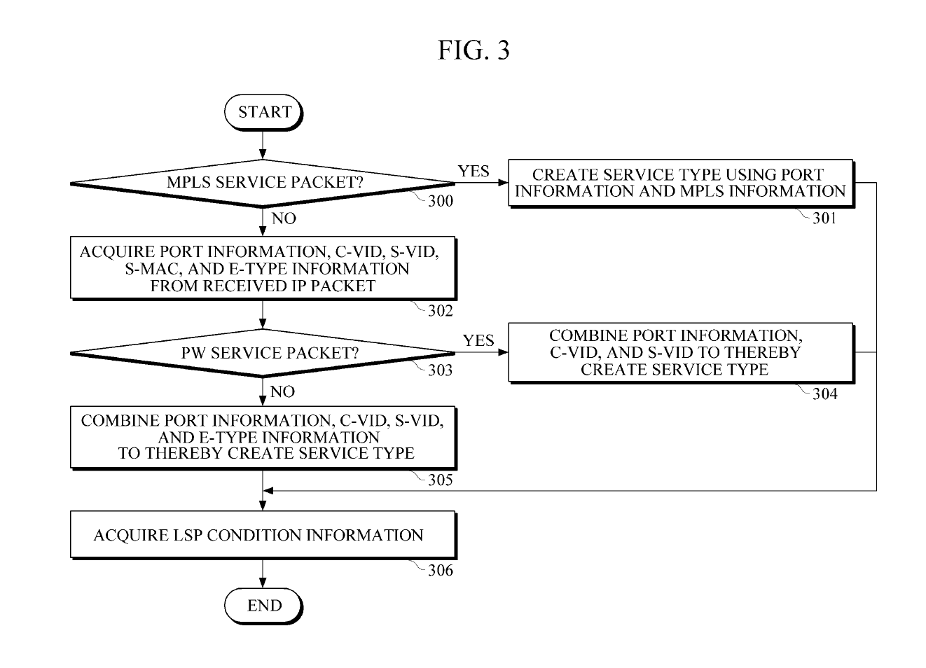

FIG. 3 is a flowchart illustrating an example of a method in which the packet processing apparatus acquires LSP condition information for extracting LSP information.

Referring to FIG. 3, the packet processing apparatus determines whether the reception packet is a MPLS service packet, a PW service packet, or an IP service packet with reference to the field information included in the reception packet, to decide the service type for transmitting packets (300). If the reception packet is determined to be a MPLS service packet, the packet processing apparatus acquires port information and MPLS label information from the field information in the reception packet. Then, the packet processing apparatus creates the service type using the port information and MPLS label information (301). Successively, the packet processing apparatus acquires LSP condition information including Packet Transport Layer (PTL) index information for extracting LSP information associated with the service type created in operation 301, from a MPLS ILM table database (306).

Meanwhile, if the reception packet is determined to be a PW service packet, the packet processing apparatus creates the service type by combining port information, C-VID information, and S-VID information, which are included in the field information of the reception packet (302 and 303). Then, the packet processing apparatus acquires LSP condition information including PTL index information for extracting LSP information associated with the service type created in operation 303, from a PW FEC table database (306). Meanwhile, if the reception packet is determined to be an IP service packet, the packet processing apparatus acquires port information, C-VID information, S-VID information, E-type information, etc., which are included in the field information of the reception packet (304). Then, the packet processing apparatus creates a service type using the port information, C-VID information, S-VID information, S-MAC information, E-type information, etc. (305). Successively, the packet processing apparatus acquires LSP condition information including PTL index information associated with the service type created in operation 305, from an IP FECT table database (306).

As such, the packet processing apparatus may create a service type using information included in a reception packet, and acquire LSP condition information including PTL index information for extracting LSP information, according to the type of the reception packet.

Returning again to FIG. 2, after the LSP condition information is acquired according to the type of the reception packet, the packet processing apparatus acquires header information and forwarding information including Transport LSP (TLSP), Service LSP (SLSP), or Encapsulation LSP (ELSP) label information for including the LSP information, from a NHLFE table database, according to whether the PTL index information included in the LSP condition information is identical to predetermined PTL index information (204). After the header information and forwarding information including the SLSP label information are acquired, the packet processing apparatus acquires the SLSP label information included in the forwarding information, and token bucket profile information and a token bucket index for policing and shaping to guarantee QoS, and then determines whether the SLSP label information is identical to SLSP information stored in a Hash table database (205 and 206). If the SLSP label information included in the forwarding information is not identical to the SLSP information stored in the Hash table database, the packet processing apparatus decides a temporary service type stored in the Hash table database as a service type for transporting the reception packet (207). At this time, the packet processing apparatus updates the hash table by adding a SLSP as a new service type, its related QoS profile, etc. to the hash table through learning, and updates the service type stored in the hash table to the temporary service type.

Meanwhile, if the SLSP label information included in the forwarding information is identical to the SLSP information stored in the Hash table database, the packet processing apparatus decides the created service type as a service type for transporting the reception packet (208). At this time, the packet processing apparatus may update the service type stored in the hash table to the decided service type. Meanwhile, the packet processing apparatus determines whether a bandwidth required by the decided service type exceeds a predetermined threshold value (209), guarantees, if the required bandwidth exceeds the predetermined threshold value, QoS in the order of Green, Yellow, and Red packets, which have been color-marked through metering, and then terminates transmitting the reception packet starting from a Red packet (210). Meanwhile, if the required bandwidth does not exceed the predetermined threshold value, the packet processing apparatus updates the headers of the reception packet, encapsulates MPLS-TP related labels, and then transmits the encapsulated MPLS-TP related labels (211).

Meanwhile, if the packet received in operation 202 is determined to be a transmission packet, the packet processing apparatus may transmit the transmission packet using a method that will be described below.

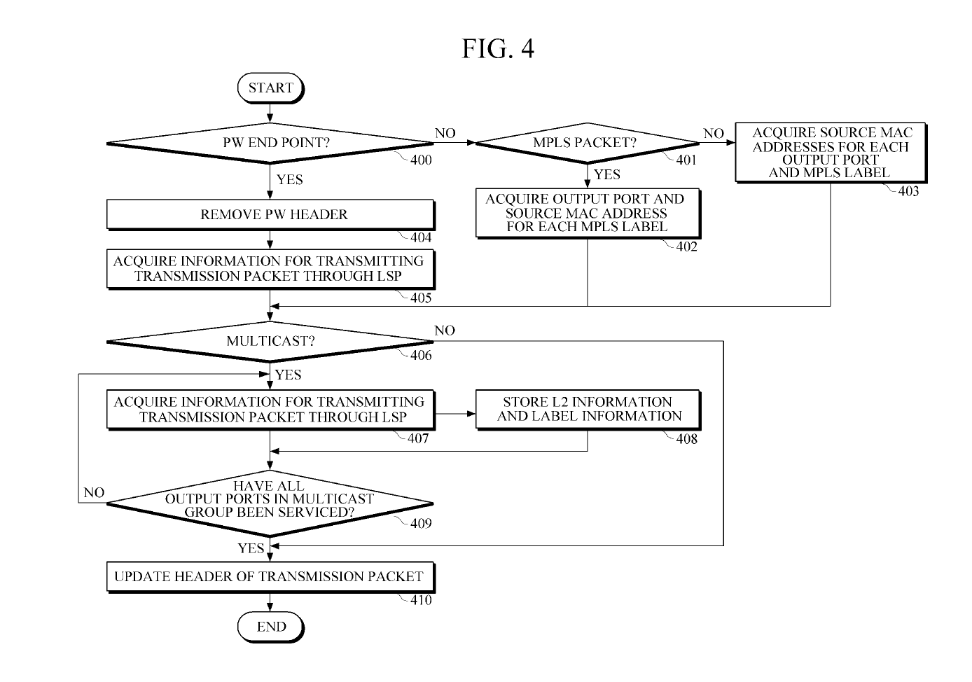

FIG. 4 is a flowchart illustrating an example of a method in which the packet processing apparatus located in the MPLS-TP network transmits transmission packets.

Referring to FIG. 4, if the received packet is determined to be a transmission packet, the packet processing apparatus determines whether a destination to which the transmission packet has to be transmitted through an established LSP is a PW end point (400). Then, the packet processing apparatus acquires LSP transport information for transmitting the transmission packet through the LSP, or acquires a source MAC address of the transmission packet for each output port or for each MPLS label, according to the result of the determination. That is, if a destination to which the transmission packet has to be transmitted is no PW end point, the packet processing apparatus determines whether the transmission packet is a MPLS packet (401). If the transmission packet is a MPLS packet, the packet processing apparatus acquires source MAC addresses of the transmission packet for each output port and for each MPLS label, from a port-label table database (402). Meanwhile, if the transmission packet is no MPLS packet, the packet processing apparatus acquires a source MAC address of the transmission packet for each output port from a S-MAC table database (403). Thereafter, the packet processing apparatus determines in which one of multicast and unicast manners the transmission packet has to be transmitted, based on field information included in the transmission packet (406). If the transmission packet is determined to have to be transmitted in a unicast manner, the packet processing apparatus acquires tag control information from the source MAC address information for each output port and internal headers to determine whether to add a new tag or to modify an existing tag, thereby updating the source MAC address information for each output port or for each MPLS label (410).

Meanwhile, if the transmission packet is determined to have to be transmitted in a multicast manner, the packet processing apparatus acquires LSP transport information for transmitting the transmission packet through the LSP, from a multicast table database (407). Then, the packet processing apparatus determines whether all output ports in a multicast group have been serviced (409), and again acquires, if any output port to be able to be serviced remains in the multicast group, LSP transport information for transmitting the transmission packet through the LSP (407). Meanwhile, if all the output ports in the multicast group have been used, the packet processing apparatus determines whether to change the headers of the transmission packet for each output port in the multicast group to have to be transmitted, to add a new tag or to modify an existing tag, based on the LSP transport information, to thereby perform update (410).

If it is determined in operation 400 that a destination to which the transmission packet has to be transmitted is a PW end point, the packet processing apparatus removes a PW header included in the transmission packet (404). Then, the packet processing apparatus acquires LSP transport information for transmitting the transmission packet through the LSP, from a PW multicast table database (405). That is, the packet processing apparatus acquires a SDT, a PTL index, a tag value, a TM queue index, and control information, which are needed to transmit the transmission packet through the LSP, from the PW multicast table database. Thereafter, the packet processing apparatus determines in which one of multicast and unicast manners the transmission packet has to be transmitted (406). If the transmission packet is determined to have to be transmitted in a unicast manner, the packet processing apparatus updates the headers of the transmission packet based on the LSP transport information acquired in operation 405 (410). Meanwhile, if the transmission packet is determined to have to be transmitted in a multicast manner, the packet processing apparatus acquires LSP transport information for transmitting the transmission packet through the LSP, from the multicast table database (407). Then, the packet processing apparatus stores L2 information and label information from the PW multicast table (408), and determines whether all output ports in the multicast group have been serviced (409). If any output port to be able to be used remains in the multicast group, the packet processing apparatus again acquires LSP transmission information for transmitting the transmission packet through the LSP (407). Meanwhile, if the output ports in the multicast group have been all used, the packet processing apparatus updates the headers of the transmission packet based on the LSP transmission information acquired in operation 407.

So far, a method in which a packet processing apparatus located in a MPLS-TP network transmits reception or transmission packets received from at least one of a plurality of local networks, provider bridge networks, and MPLS networks through a LSP has been described in detail. Hereinafter, individual components of the packet processing apparatus which transmits packets received from an external network through a LSP in a MPLS-TP network, according to a service type will be described in detail.

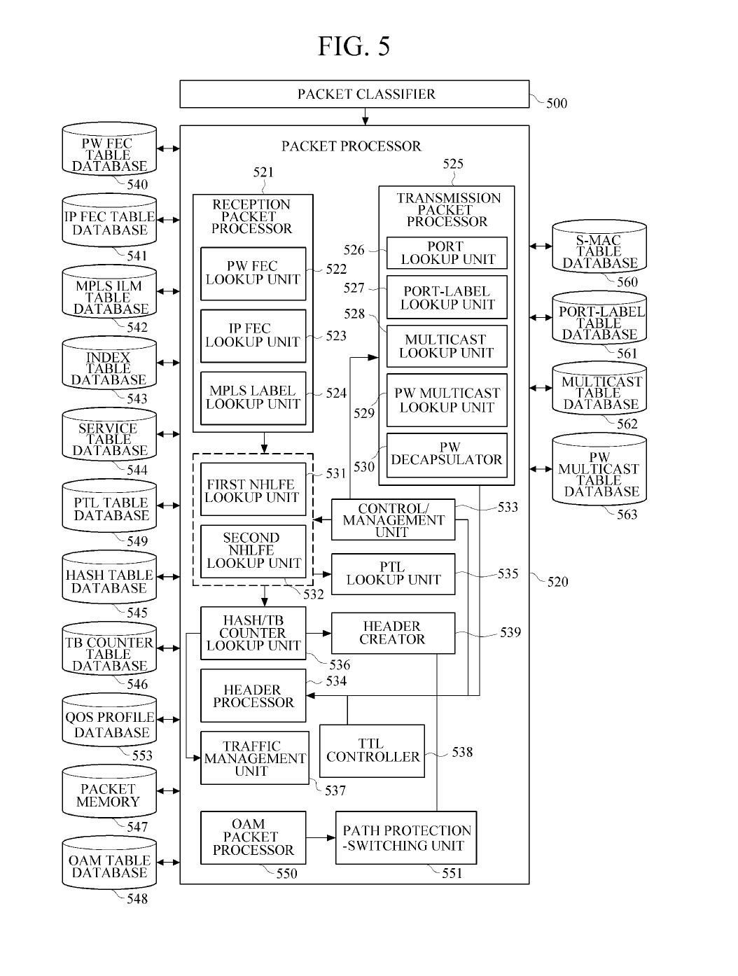

FIG. 5 is a diagram illustrating an example of a packet processing apparatus of providing a packet transport service.

Referring to FIG. 5, the packet processing apparatus includes a packet classifier 500 and a packet processor 520. When a packet is received from at least one network among a plurality of local networks, provider bridge networks, and MPLS networks, the packet classifier 500 extracts Ethernet header information, field information, and MPLS label information from the received packet, according to control information of a control register. Then, the packet classifier 500 determines whether the received packet is a control packet or a normal packet, based on port information included in the field information, and transmits, if the received packet is a control packet, the packet to an upper control channel through a CPU interface. Meanwhile, if the received packet is a normal packet, the packet classifier 500 determines whether the normal packet is a reception packet or a transmission packet. If the normal packet is a reception packet, the packet classifier 500 decides a service type for transmitting the reception packet, according to control information of the control register.

The packet processor 520 acquires LSP condition information or address information from the field information of the normal packet, transmits the packet according to a service type that is decided by the packet classifier 500 with reference to the LSP condition information or the address information, and then updates the header and address information of the packet. The packet processor 520 may include a reception packet processor 521 and a transmission packet processor 525 to acquire the LSP condition information or the address information from the field information of the normal packet. The reception packet processor creates, if the received packet is a reception packet, a service type related to the reception packet and acquires LSP condition information from a table associated with the service type. If the received packet is a transmission packet, the transmission packet processor 525 acquires LSP transmission information or address information for transmitting the transmission packet through the LSP, according to whether a destination to which the transmission packet has to be transmitted is a PW end point. As such, LSP condition information or address information may be acquired from the field information of a received reception/transmission packet through the reception packet processor 521 and the transmission packet processor 525. In more detail, the reception packet processor 521 may include a PW FEC lookup unit 522, an IP FEC lookup unit 523, and a MPLS label lookup unit 524, and the transmission packet processor 525 may include a port lookup unit 526, a port-label lookup unit 527, a multicast lookup unit 528, a PW multicast lookup unit 529, and a PW decapsulator 530. The PW FEC lookup unit 522 creates and manages the service type by combining port information, C-VID information, and S-VID information included in the field information of the reception packet, according to the service type decided by the packet classifier 500. Also, the PW FEC lookup unit 522 acquires PTL index information and tag control information from a PW FEC table database 540, wherein the PTL index information is used to acquire parameter values for guaranteeing a LSP and QoS, and the tag information is used for other control. Here, the PW FEC table database 540 stores PTL index information for extracting LSP information for establishing a LSP in a MPLS-TP network through the CPU interface from the upper control channel, and tag control information for other controls the PTL index information being used in a first NHLFE lookup unit 531 which will be described later.

The IP FEC lookup unit 523 creates the service type decided by the packet classifier 500, using port information, C-VID information, S-VID information, a source MAC address, and E-type (Ether Type) information included in the field information of the reception packet, which have been extracted by the packet classifier 500. Also, the IP FEC lookup unit 523 acquires PTL index information for acquiring parameter values for guaranteeing a LSP and QoS, a flag for controlling an ELSP, and ELSP label information, from an IP FEC table database 541. The IP FEC table database 541 stores PTL index information for extracting LSP information for establishing a LSP in a MPLS-TP network through the CPU interface from the upper control channel, and ELSP and ELSP label information for other control, the PTL index information being used in the first NHLFE lookup unit 531.

The MPLS label lookup unit 524 creates the service type decided by the packet classifier 500 using port information and MPLS label information included in the field information of the reception packet extracted by the packet classifier 500. Also, the MPLS label lookup unit 524 acquires PTL index information for acquiring parameter values for guaranteeing a LSP and QoS, a Service Delimiting Tag (SDT), a new tag, MPLS control information, and tag control information for other control, from a MPLS ILM table database 542. Here, the MPLS ILM table database 542 stores PTL index information for extracting LSP information in the MPLS-TP network through the CPU interface from the upper control channel, a SDT, a new tag, MPLS control information, and tag control information for other control, the PTL index information being used in the first NHLFE lookup unit 531.

As such, if a service type is created and information for extracting LSP information is acquired by at least one lookup unit of the PW FEC lookup unit 522, the IP FEC lookup unit 523, and the MPLS label lookup unit 524, the first NHLFE lookup unit 531 decides the service type created by at least one lookup unit of the PW FEC lookup unit 522, the IP FEC lookup unit 523, and the MPLS label lookup unit 524. That is, the first NHLFE lookup unit 531 decides the service type created by the corresponding lookup unit, according to whether information acquired by at least one lookup unit of the PW FEC lookup unit 522, the IP FEC lookup unit 523, and the MPLS label lookup unit 524 is identical to pre-stored information. According to an example, the first NHLFE lookup unit 531 determines whether PTL index information among information acquired by at least one lookup unit of the PW FEC lookup unit 522, the IP FEC lookup unit 523, and the MPLS label lookup unit 524 is identical to pre-stored PTL index information, and decides the service type created by the corresponding lookup unit.

Also, the first NHLFE lookup part 531 acquires a switched fabric and transmission/reception output port for transmitting the reception packet through the LSP established in the MPLS-TP network, a tag value, a TM queue index, a Token Bucket (TB) profile, a packet counter, and tag control information for other control, from the index table database 543.

Meanwhile, a second NHLFE lookup unit 532 determines whether PTL index information among information acquired by at least one lookup unit of the PW FEC lookup unit 522, the IP FEC lookup unit 523, and the MPLS label lookup unit 524 is identical to pre-stored PTL index information, and decides, if the PTL index information is identical to the pre-stored PTL index information, the service type created by the corresponding lookup unit. Also, the second NHLFE lookup unit 532 acquires MPLS-TP layer-related information and label control information for including LSP information established in the MPLS-TP network in the reception packet, from a service table database 544. Here, the service table database 544 stores a SLSP label, a TLSP label, EXP, Stack, TTL, a PTL index, Destination MAC (D-MAC), or Multicast ID (M-ID) information, and layer control information, related to the MPLS-TP layer, in order to include LSP information established in the MPLS-TP network through the CPU interface through the upper control channel in the corresponding reception packet.

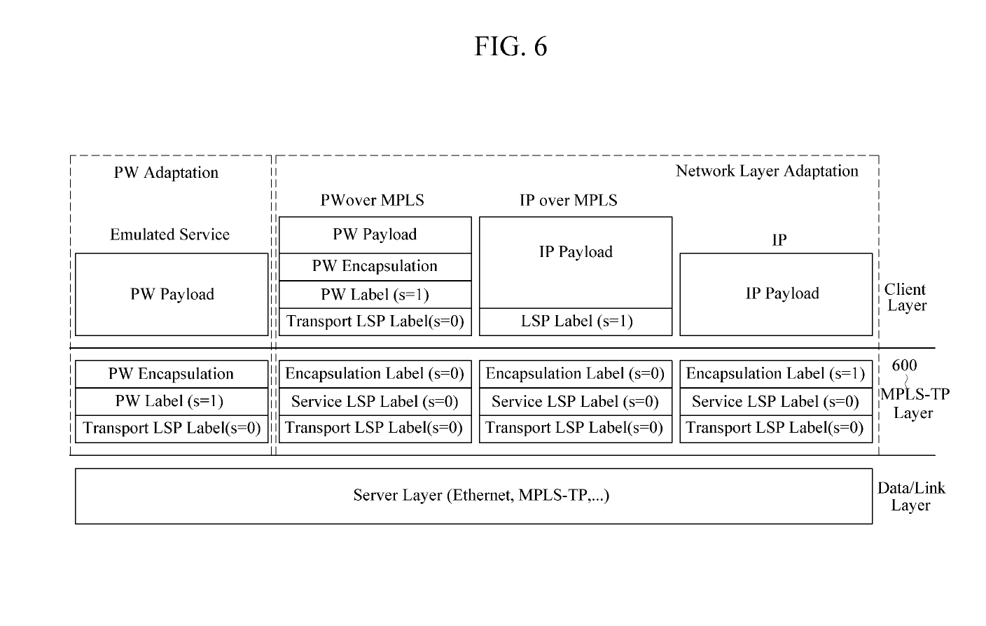

As such, the MPLS-TP layer-related labels that are stored in the service table database 544 are shown in FIG. 6.

FIG. 6 illustrates an example of a service type that is provided based on a MPLS-TP standard in the packet processing apparatus.

As shown in FIG. 6, in regard of the MPLS-TP standard, a PW adaptation layer (PWAL) and a Network adaptation layer (NAL) are divided, and an ELSP among labels of a MPLS-TP layer 600 is used selectively according to a service type. Meanwhile, “layer stack” that is mentioned in this specification means stacking all basic labels (SLSP and TLSP, or ELSP, SLSP, and TLSP) of the MPLS-TP layer and “label stack” means stacking only TLSP, which are supported by label control information of a control/management unit 533 (see FIG. 5). Accordingly, the second NHLFE lookup unit 532 acquires a SLSP label, a TLSP label, EXP, Stack, a PTL index, TTL, a PTL index, D-MAC or M-ID information, and layer control information, related to the MPLS-TP layer, according to a control command from the control/management unit 533.

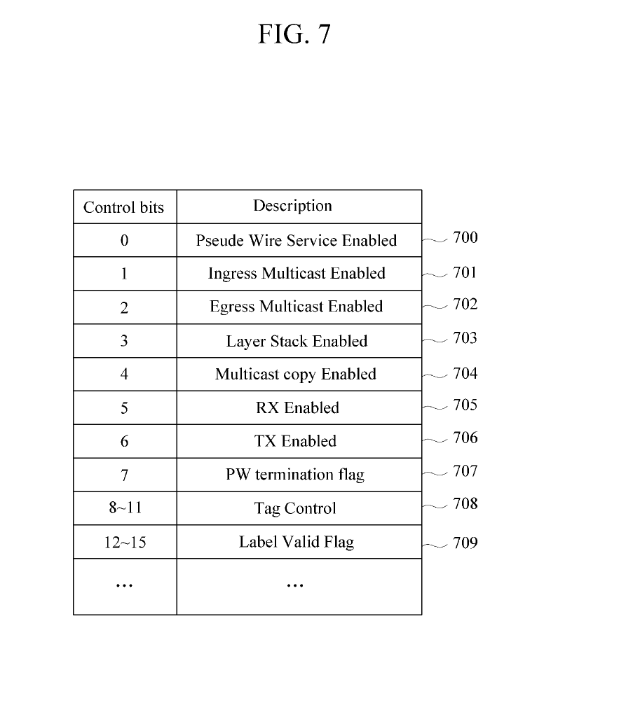

Meanwhile, control signals that are managed by the control/management unit 533 are shown in FIG. 7.

FIG. 7 illustrates examples of control signals that are controlled by the control/management unit 533(see FIG. 5) of the packet processing apparatus.

As shown in FIG. 7, the control signals include a PW service enable signal 700, ingress and egress multicast enable signals 701 and 702, a MPLS-TP layer stack enable signal 703, a multicast copy enable signal 704, RX and TX enable signals 705 and 706, a PW termination flag 707, a tag control signal 708, and a label valid flag 709. Accordingly, the control/management unit 533 transmits the control signals to the second NHLFE lookup unit 532, the header processor 534, the multicast lookup unit 528, and the PW multicast lookup unit 529.

Meanwhile, according to another example, the packet processor 520 further includes a PTL lookup unit 535. The PTL lookup unit 535 acquires a TB index for guaranteeing QoS, from SLSP label information acquired from the second NHLFE lookup unit 532, and a TB index for polishing and shaping and TB profile information for guaranteeing QoS, from the PTL table database 549.

Meanwhile, according to another example, the packet processor 520 further includes a Hash/TB counter lookup unit 536 and a traffic management unit 537. The Hash/TB counter lookup unit 536 determines whether the SLSP label information acquired by the second NHLFE lookup unit 532 is identical to SLSP label information stored in the hash table database 545. If the SLSP label information acquired by the second NHLFE lookup unit 532 is not identical to the SLSP label information stored in the hash table database 545, the Hash/TB counter lookup unit 536 updates the Hash table database 545 by adding new Hash entries to TB profile information, etc. acquired by the PTL table database 549 through learning to thereby add a new table type to the Hash table database 545, and decides to transmit the reception packet according to the new table type.

Meanwhile, if the SLSP label information acquired by the second NHLFE lookup unit 532 is identical to the SLSP label information stored in the hash table database 545, the Hash/TB counter lookup unit 536 decides to transmit the reception packet according to the created service type. Then, the Hash/TB counter lookup unit 536 updates a service type pre-stored in the Hash table database 545 to the corresponding service type. At this time, the Hash/TB counter lookup unit 536 determines whether a bandwidth required by the corresponding service type exceeds a threshold value stored in a TB counter table database 546, color-marks, if the bandwidth exceeds the threshold value, the reception packet using a color, such as green, yellow, red, etc., through metering, and then transmits a control signal regarding terminating transmitting the reception packet to the traffic management unit 537.

Accordingly, the traffic management unit 537 terminates transmitting the corresponding reception packet according to the control signal received from the Hash/TB counter lookup unit 536. Also, the traffic management unit 537 applies policing and shaping to the corresponding reception packet according to QoS profile information of a QoS profile database 553, the QoS profile information set through the CPU interface from the upper control channel, and then transmits the packet subject to polishing and shaping.

According to another example, the packet processor 520 further includes a TTL controller 538. The TTL controller 538 subtracts a TTL if the most significant label (TLSP or SLSP) related to the MPLS-TP layer is Swap, copies the TTL in a TTL processing mode (a short pipe model or a uniform model) if the most significant label is Pop, and initializes the TTL to a TTL value acquired by the second NHLFE lookup database 532 if the most significant label is Push.

Meanwhile, according to another example, the packet processor 220 further includes a header processor 534 and a header creator 539. The header creator 539 acquires an internal header 1 including information regarding an input switch port and an output switch port at a S-Tag position based on information acquired by the first and second NHLFE lookup units 531 and 532. Then, the header creator 539 creates an internal header 2 at a S-MAC position, wherein the internal header 2 includes output line card port information, multicast control information, PW position control information, PW tag control information, SDT type information, color-marked color information for QoS control, switch state information indicating an activated switch or a deactivated switch, path state information indicating a working path for protection switching or a protection path, control information indicating whether SLSP has been pushed, and new tag information. In addition, the header creator 539 uses an Internal header 3 as unicast D-MAC at a D-MAC position in the case of unicast, and creates the internal header 3 including multicast ID(M-ID) information in the case of multicast.

The header processor 534 sets a Push, Swap, or Pop function of TLSP and SLSP labels or an ELSP label, related to the MPLS-TP layer, according to a control command from the control/management unit 533 in order to transmit the reception packet through the LSP established in the MPLS-TP network to a destination network.

The header processor 534 updates a TTL field of the most significant label (TLSP or SLSP) related to the MPLS-TP layer according to factor values applied by TTL subtraction, TTL copy, TTL initialization, etc. from the TTL controller 538. Also, the header processor 534 inserts a tag into the field information of the reception packet, removes a tag from the field information of the reception packet, or changes a tag included in the field information of the reception packet in order to optimize the reception packet for the destination network. The header processor 534 includes 3 internal headers created by the header creator 539 according to information acquired by the first and second NHLFE lookup units 531 and 532, in the reception packet. That is, in the case of a reception packet, the header processor 534 encapsulates the packet stored in a packet memory 547 with a TLSP label, a SLSP label, etc. acquired by the second NHLFE lookup unit 532, according to header condition information, and inserts internal headers created by the header creator 539 into the headers of the reception packet. In the case of a transmission packet, the header processor 534 removes internal headers, updates a D-MAC address at the positions of the internal headers only if the transmission packet is received in a multicast manner, updates a S-MAC address, and then adds, removes or changes a L2 VLAN tag in order to optimize the transmission packet for a destination network which may be a local network, a provider bridge network, or a MPLS network.

Meanwhile, according to another example, the packet processor 520 further includes an OAM packet processor 550 and a path protection switching unit 551. The OAM packet processor 550 checks whether there is an error on the transmission path of a packet classified by the packet classifier 500, based on SLSP OAM, TLSP OAM, and PW OAM stored in an OAM table database 548. That is, the OAM packet processor 550 transmits a Continuity Check Message (CCM) to a received packet and receives a response message to thereby check whether there is an error on the transmission path of the corresponding packet. However, it is also possible that the OAM packet processor 550 transmits a Link Trace Message (LTM), a Link Trace Reply (LTR), a LoopBack Message (LBM), a LoopBack Reply (LBR), etc. to the upper processor through the CPU interface and receives a response message from the upper processor to thereby check whether there is an error on the transmission path of a received packet. If it is checked that there is an error on the path according to the response message, the path protection switching unit 51 protection-switches a currently serviced path to a substitutable path.

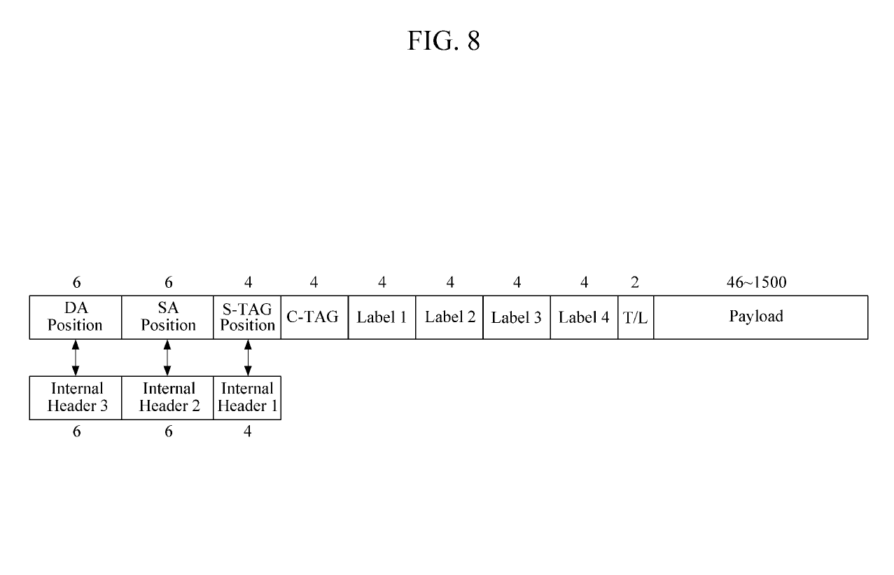

Meanwhile, if a normal packet classified by the packet classifier 500 is a transmission packet, as described above, the transmission packet processor 525 may update the headers of the transmission packet, and adds, removes, or changes a SDT and a VLAN tag, using information acquired by at least one lookup unit of the port lookup unit 526, the port-label lookup unit 527, the multicast lookup unit 528, and the PW multicast lookup unit 529. If a packet classified into a normal packet is a transmission packet, not a MPLS packet, as illustrated in FIG. 8, the port lookup unit 526 updates a source MAC address of an output port written in the field information of the transmission packet including internal headers, and acquires the source MAC address, a TM queue index, and packet counter index information of the output port from a S-MAC table database 560.

FIG. 8 is an example showing the positions of internal headers 1, 2, and 3 included in field information of a transmission packet.

As illustrated in FIG. 8, the internal headers 1, 2, and 3 are included at S-TAG, S-MAC, and D-MAC positions, respectively. Accordingly, the port lookup unit 526 acquires the internal headers 1, 2, and 3 from the S-TAG, S-MAC, and D-MAC, and updates a source MAC address based on output port information contained in the internal headers 1, 2, and 3.

Meanwhile, if a packet classified into a normal packet is a MPLS transmission packet, the port-label lookup unit 527 updates source MAC addresses of an output port and the most significant MPLS label included in field information of the transmission packet including internal headers, and acquires a source MAC address, a TM queue index, and packet counter index information of the output port from a port-label table database 561. Meanwhile, the multicast lookup unit 528 decides whether to transmit the transmission packet in a multicast manner or in a unicast manner, based on M-ID information and a flag of at least one label included in the field information of the transmission packet. Also, the multicast lookup unit 528 acquires a D-MAX address, a PTL index, MPLS-TS layer labels, EXPs, STACKs, a tag value, a TM queue index, a counter index, and control information for transmitting the transmission packet through a LSP established in a MPLS-TP network, from a multicast table database 562.

Meanwhile, the PW multicast lookup unit 529 determines whether to transmit the transmission packet in a multicast manner or in a unicast manner, based on M-ID information and a flag of at least one label included in field information of the transmission packet. Also, the PW multicast lookup unit 529 acquires a SDT, a PTL index, a tag value, a TM queue index, and control information for transmitting the transmission packet through the LSP established in the MPLS-TP network, from a PW multicast table database 563. At this time, if a PW termination flag is in an “enabled” state, a PW decapsulation unit 530 removes PW.

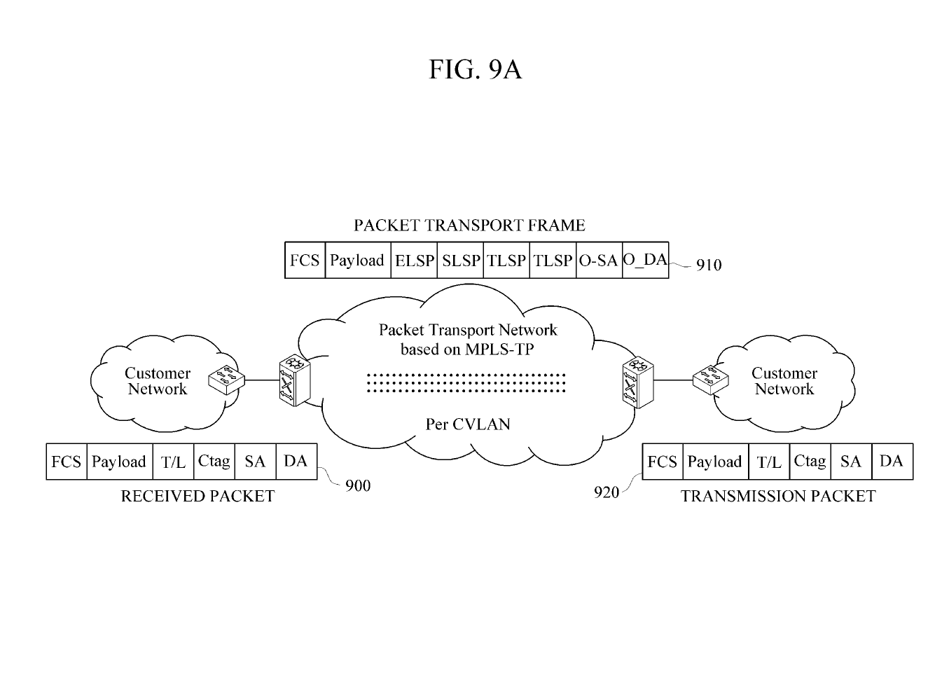

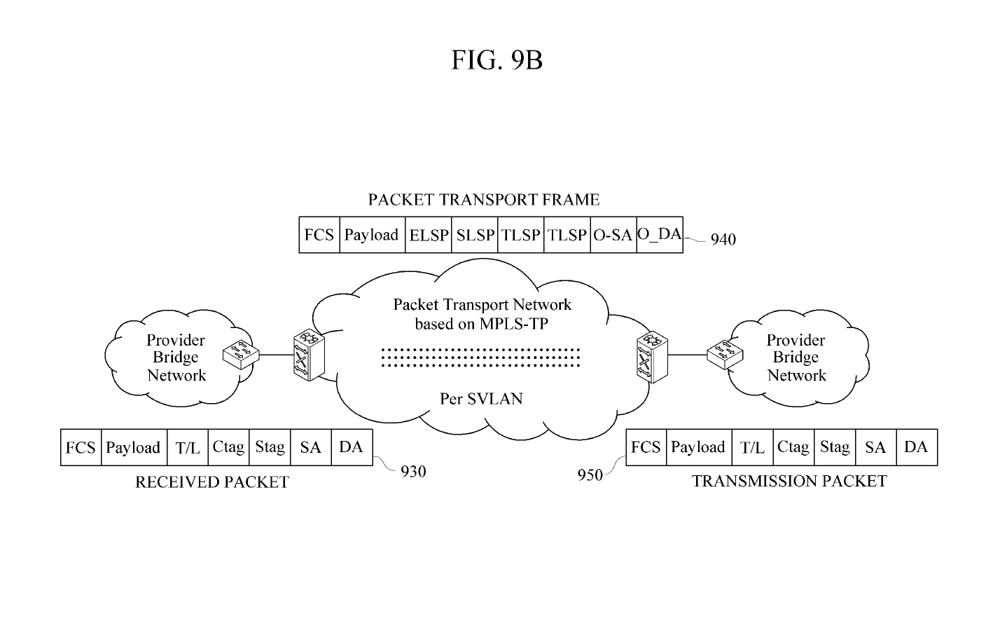

So far, the individual components of the packet processing apparatus have been described in detail. Hereinafter, an example where the packet processing apparatus performs a packet transmission service will be described in detail with reference to FIGS. 9, 10, and 11.

FIG. 9A is a view for explaining an example of a process of providing a packet transport service between customer networks through a LSP established in a MPLS-TP network, and FIG. 9B is a view for explaining an example of a process of providing a packet transport service between provider bridge networks through another LSP established in the MPLS-TP network.

First, FIG. 9A is a view for explaining an example of providing a network adaptation layer service #1 using an input port and C-Tag included in a received packet.

Referring to FIGS. 1 and 9A, the network adaptation layer service #1 using the input port and C-tag provides a packet service through LSP#1 of a MPLS-TP network via a route of user 1→access switch located in a customer network 20→packet processing apparatus 100h→packet processing apparatus 100g→access switch located in a customer network 30→user 3. That is, a packet 900 received through the customer network 20 is converted to a packet transport frame 910 in the MPLS-TP network, and the packet transport frame 910 is transmitted to the packet processing apparatus 100g located in a destination network via the packet processing apparatus 100h. Here, existence or absence of ELSP in the packet transport frame 910 indicates whether the packet transport frame 910 is determined to be E-type upon deciding a service type, one of two TLSPs is necessary, and the other one is selectively label-stacked. Accordingly, it is possible to add a TLSP label stack according to the network components of a MPLS-TP network. Meanwhile, the packet processing apparatus 100g located in the destination network detects existence or absence of C-tag and S-tag by checking the corresponding packet transport frame 910 using tag control information to update headers of the packet transport frame 910, and then transmits a transmission packet 920 related to the packet transport frame 910 to the customer network 30 which is a destination.

FIG. 9B is a view for explaining an example of providing a network adaptation layer service #2 using an input port and S-Tag included in a received packet. Referring to FIG. 1, the network adaptation layer service #2 using the input port and S-Tag provides a packet service through LSP#2 and LSP#11 of a MPLS-TP network via a route of user 2→access switch located in the provider bridge network 50→packet processing apparatus 100a→packet processing apparatus 100f→packet processing apparatus 100e→provider bridge network 60→user 5. That is, a packet received through the provider bridge network 50 is converted to a packet transport frame 940 in the MPLS-TP network, and the packet transport frame 940 is transmitted to the packet processing apparatus 100e located in a destination network. Here, existence or absence of ELSP in the packet transport frame 940 indicates whether the packet transport frame 940 is determined to be E-type upon deciding a service type, one of two TLSPs is necessary, and the other one is selectively label-stacked. Accordingly, it is possible to add a TLSP label stack according to the network components of the MPLS-TP network. Meanwhile, the packet processing apparatus 100e located in the destination network detects existence or absence of C-Tag and S-Tag by checking the packet transport frame 940 using tag control information to update headers of the packet transport frame 940, and then transmits a transmission packet 950 related to the packet transport frame 940 to the provider bridge network 60 which is a destination.

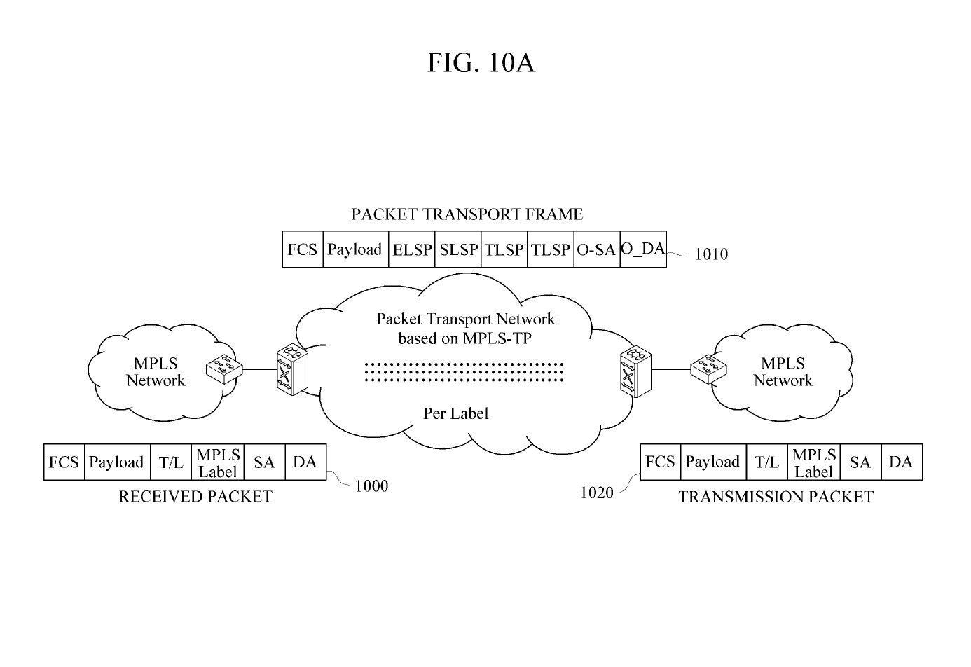

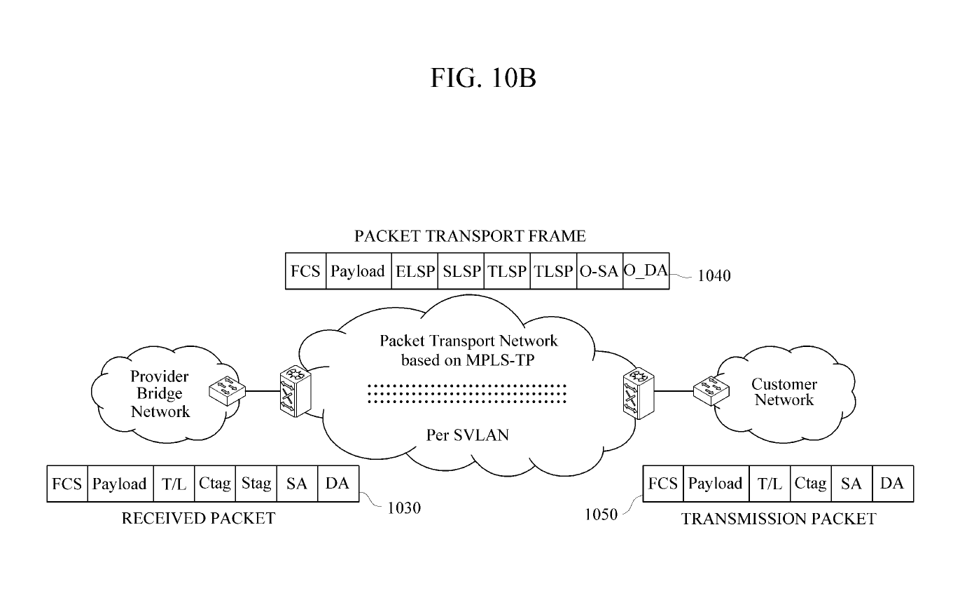

FIG. 10A is a view for explaining an example of a process of providing a packet transport service between MPLS networks through a LSP established in the MPLS-TP network, and FIG. 10B is a view for explaining an example of a process of providing a packet transport service between a provider bridge network and a customer network through another LSP established in the MPLS-TP network.

FIG. 10A is a view for explaining an example of providing a network adaptation layer service #3 using an input port and a MPLS label included in a received packet. Referring to FIG. 1, the network adaptation layer service #3 using the input port and the MPLS label provides a packet service through LSP#8 and LSP#7 of the MPLS-TP network via a route of access switch located in a MPLS network 70→packet processing apparatus 100b→packet processing apparatus 100c→packet processing apparatus 100f→access switch located in a MPLS network 80. That is, a packet 1000 received through the MPLS network 70 is converted to a packet transport frame 1010 in the MPLS-TP network, and the packet transport frame 1010 is transmitted to a packet processing apparatus 100c located in a destination network. Here, existence or absence of ELSP in the packet transport frame 1010 indicates whether the packet transport frame 1010 is determined to be E-type upon deciding a service type, one of two TLSPs is necessary, and the other one is selectively label-stacked. Accordingly, it is possible to add a TLSP label stack according to the network components of the MPLS-TP network. Meanwhile, the packet processing apparatus 100c located in the destination network detects existence or absence of C-Tag and S-Tag by checking the packet transport frame 1010 using tag control information to update headers of the packet transport frame 1010, and then transmits a transmission packet 1020 related to the packet transport frame 1010 to the MPLS network 80 which is a destination.

FIG. 10B is a view for explaining an example of providing a network adaptation layer service #4 using an input port and S-Tag of a received packet when a destination network is different from that of the network adaptation layer service #2. Referring to FIG. 1, the network adaptation layer service #4 using the input port and S-Tag of a received packet provides a packet service through LSP#4 and LSP#10 via a route of user 2→access switch located in a provider bridge network 50→packet processing apparatus 100a→packet processing apparatus 100b→packet processing apparatus 100d→access switch located in a customer network 40→user 4. That is, a packet 1000 received through the provider bridge network 50 is converted to a packet transport frame 1030 in the MPLS-TP network, and the packet transport frame 1030 is transmitted to the packet processing apparatus 100d located in a destination network. Here, existence or absence of ELSP in the packet transport frame 1030 indicates whether the packet transport frame 1030 is determined to be E-type upon deciding a service type, one of two TLSPs is necessary, and the other one is selectively label-stacked. Accordingly, it is possible to add a TLSP label stack according to the network component of the MPLS-TP network. Meanwhile, the packet processing apparatus 100d located in a destination network decides existence or absence of C-Tag and S-Tag by checking the packet transport frame 1010 using tag control information to update headers of the corresponding packet transport frame 1010, and then transmits a transmission packet 1050 related to the packet transport frame 1040 to a customer network 40 which is a destination.

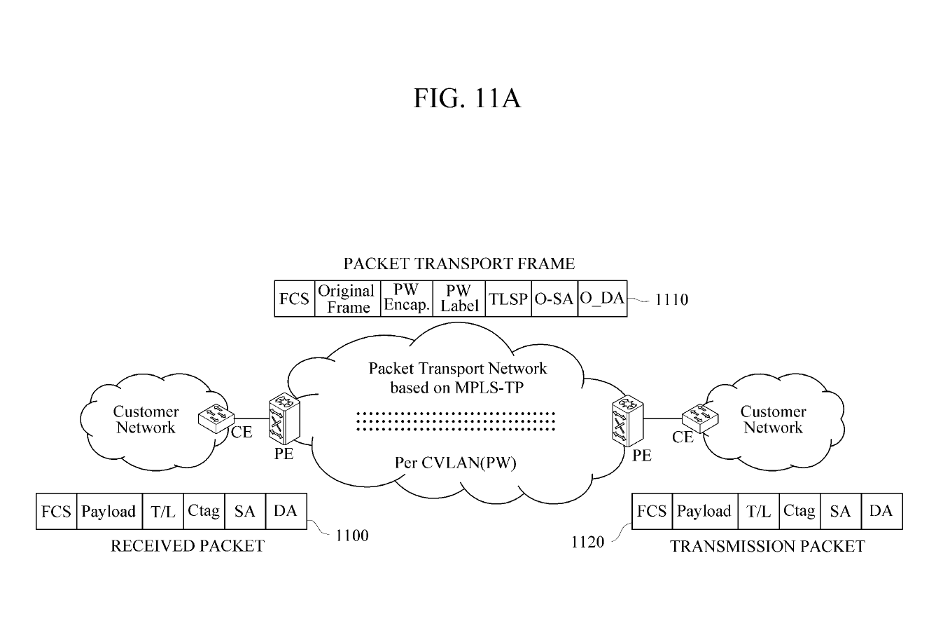

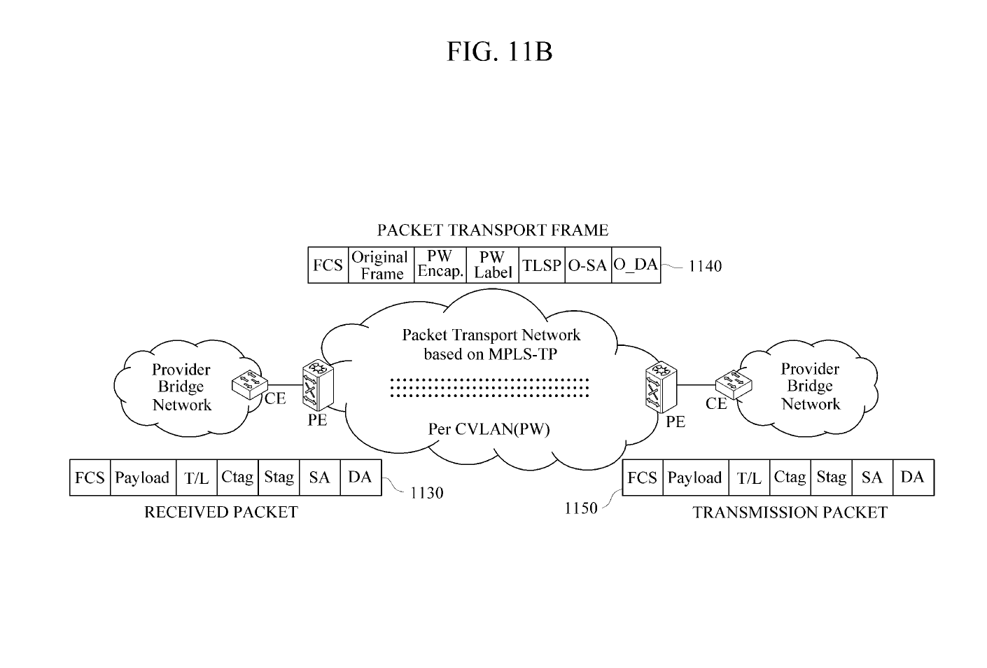

FIG. 11A is a view for explaining another example of a process of providing a packet transport service between customer networks through a LSP established in the MPLS-TP network, and FIG. 11B is a view for explaining another example of a process of providing a packet transport service between provider bridge networks through another LSP established in the MPLS-TP network.

FIG. 11A is a view for explaining an example of providing a PW adaptation layer service #5 using an input port and C-Tag included in a received packet. Referring to FIG. 1, the PW adaptation layer service #5 using the input port and C-Tag included in the received packet provides a packet service through LSP#4, LSP#8 and LSP#10 of the MPLS-TP network via a route of customer edge node 21→packet processing apparatus 100a→packet processing apparatus 100f→customer edge node 22. That is, a packet 110 received through the customer edge node 21 is converted to a packet transport frame 1110 in the MPLS-TP network, and the packet transport frame 1110 is transmitted to the packet processing apparatus 100f located in a destination network. PW Encap, PW Label, and TLSP included in the packet transport frame 1110 are necessary, and a TLSP label stack may be added according to the components of the MPLS-TP network. Meanwhile, the packet processing apparatus 100f located in the destination network inserts, removes or changes C-Tag and S-Tag using SDT control information related to one of two modes (Raw mode and Tagged mode) of PW. Thereafter, the packet processing apparatus 100f updates headers of the corresponding packet transport frame 1110, and then transmits a transmission packet 1120 related to the corresponding packet transport frame 1110 to the customer edge node 22 which is a destination.

FIG. 11B is a view for explaining an example of providing a PW adaptation layer service #6 using an input port and S-Tag included in a received packet. Referring to FIG. 1, the PW adaptation layer service #6 using the input port and S-Tag provides a packet service through LSP#2 of a MPLS-TP network via a route of customer edge node 51→packet processing apparatus 100a→packet processing apparatus 100f→packet customer edge node 52. That is, a packet 1130 received through the customer edge node 51 is converted to a packet transport frame 1140 in the MPLS-TP network, and the packet transport frame 1140 is transmitted to the packet processing apparatus 100f located in a destination network. Here, PW Encap, PW Label, and TLSP included in the packet transport frame 1140 are necessary, and a TLSP label stack may be added according to the components of the MPLS-TP network. Meanwhile, the packet processing apparatus 100f located in the destination network determines whether to insert, remove, or change C-Tag and S-Tag using SDT control information related to one of two modes (Raw mode and Tagged mode) of PW. Thereafter, the packet processing apparatus 100f updates headers of the corresponding packet transport frame 1140, and then transmits a transmission packet related to the corresponding packet transport frame 1140 to the customer edge node 52 which is a destination.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of transporting a reception packet in a packet processing apparatus located in a Multi Protocol Label Switching-Transport Profile (MPLS-TP) network, the method comprising:
creating a service type related to field information of the reception packet, and acquiring Label Switched Path (LSP) condition information from a table related to the service type;
acquiring forwarding information and header information from a NHLFE table, according to whether PTL index information included in the LSP condition information is identical to predetermined PTL index information;
deciding the created service type or a temporary service type, according to whether Service LSP (SLSP) label information of the forwarding information is identical to SLSP information stored in a hash table; and
updating a header of the reception packet and encapsulating a MPLS-TP label to transmit the reception packet or terminate transmitting the reception packet, according to whether a bandwidth required by the decided service type exceeds a pre-set threshold value.

2. The method of claim 1, wherein the acquiring of the LSP condition information comprises:
determining whether the reception packet is a MPLS service packet, a PW service packet, or an IP service packet with reference to the field information of the reception packet, thus deciding the service type for transmitting packets;
creating, if the reception packet is determined to be a MPLS service packet, the decided service type using port information and MPLS label information included in the field information of the reception packet; and
acquiring the LSP condition information including the PTL index information related to the service type from a MPLS ILM table.

3. The method of claim 1, wherein the acquiring of the LSP condition information comprises:
determining whether the reception packet is a MPLS service packet, a PW service packet, or an IP service packet with reference to the field information of the reception packet, thus deciding the service type for transmitting packets;
combining, if the reception packet is determined to be a PW service packet, the port information, C-VID information, and S-VID information included in the field information of the reception packet to thereby create the decided service type; and
acquiring the LSP condition information including the PTL index information related to the created service type from a PW FEC table.

4. The method of claim 1, wherein the acquiring of the LSP condition information comprises:
determining whether the reception packet is a MPLS service packet, a PW service packet, or an IP service packet with reference to the field information of the reception packet, thus deciding the service type for transmitting packets;
creating, if the reception packet is determined to be an IP service packet, the port information, the C-VID information, the S-VID information, S-MAC information, and E-Type information included in the field information of the reception packet to thereby create the decided service type; and
acquiring the LSP condition information including the PTL index information related to the created service type from an IP FEC table

5. The method of claim 1, wherein the deciding of the created service type or the temporary service type comprises:
updating, if the SLSP label information of the forwarding information is identical to the SLSP information stored in the hash table, a service type stored in the hash table to the created service type, and updating, if the SLSP label information of the forwarding information is not identical to the SLSP information stored in the hash table, the service type stored in the hash table to the temporary service type.

6. The method of claim 1, wherein the updating of the header of the reception packet and the encapsulating of the MPLS-TP label to transmit the reception packet or terminate transmitting the reception packet comprises updating, if the bandwidth required by the service type does not exceed the pre-set threshold value, the header of the reception packet and encapsulating the MPLS-TP label to transmit the reception packet, and terminating transmitting the reception packet in an order of color-marked packets through metering if the bandwidth required by the service type exceeds the pre-set threshold value.

7. A method of transmitting a transmission packet in a packet processing apparatus located in a Multi Protocol Label Switching-Transport Profile (MPLS-TP) network, the method comprising:
determining whether a destination to which the transmission packet has to be transmitted through a pre-set Label Switched Path (LSP) is a PW end point;
acquiring LSP transmission information for transmitting the transmission packet through the LSP or a source MAC address of the transmission packet for each output port or for each MPLS label, according to the result of the determination; and
determining whether to transmit the transmission packet in a multicast manner or in a unicast manner based on field information of the transmission packet, and updating a header of the transmission packet or a source MAC address of the transmission packet for each output port or for each MPLS label, according to the result of the determination.

8. The method of claim 7, wherein the acquiring of the LSP transmission information or the source MAC address of the transmission packet for each output port or for each MPLS label comprises:
removing, if the destination to which the transmission packet has to be transmitted through the LSP is a PW end point, a PW header included in the transmission packet; and
acquiring LSP transmission information for transmitting the transmission packet from a PW multicast table.

9. The method of claim 8, wherein the updating of the header of the transmission packet or the source MAC address of the transmission packet for each output port or for each MPLS label comprises:
determining whether to transmit the transmission packet in a multicast manner or in a unicast manner based on the field information included in the transmission packet;
updating, if the transmission packet is determined to have to be transmitted in the unicast manner, the header of the transmission packet based on the LSP transmission information, and transmitting, if the transmission packet is determined to have to be transmitted in the multicast manner, the LSP transmission information for transmitting the transmission packet from a multicast table, and storing L2 information and label information in the multicast table;
determining whether all ports in a multicast group have been serviced;
updating, if all the ports in the multicast group have been serviced, the header of the transmission packet using the LSP transmission information using the LSP transmission information, and again acquiring, if any port to be able to be serviced remains in the multicast group, the LSP transmission information for transmitting the transmission packet through the LSP.

10. The method of claim 7, wherein the acquiring of the LSP transmission information or the source MAC address of the transmission packet for each output port or for each MPLS label comprises:
determining, if the destination to which the transmission packet has to be transmitted through the LSP is not a PW end point, whether the transmission packet is a MPLS packet; and
acquiring, if the transmission packet is a MPLS packet, output port information and a source MAC address of the transmission packet for each MPLS label from a port-label table, and acquiring, if the transmission packet is not a MPLS packet, a source MAC address of the transmission packet for each output port from a S-MAC table.

11. The method of claim 10, wherein the updating of the header of the transmission packet or the source MAC address of the transmission packet for each output port or for each MPLS label comprises:
determining whether to transmit the transmission packet in a multicast manner or in a unicast manner, based on the field information of the transmission packet;
updating, if the transmission packet is determined to have to be transmitted in the unicast manner, the source MAC address of the transmission packet for each output port or for each MPLS label, and acquiring, if the transmission packet is determined to have to be transmitted in the multicast manner, LSP transmission information for transmitting the transmission packet through the LSP from a multicast table, and determining whether any output port to be able to be service remains in the multicast group; and
updating, if all the output ports in the multicast group have been serviced, the header of the transmission packet using the LSP transmission information, and again acquiring, if any output port to be able to be serviced remains in the multicast group, the LSP transmission information for transmitting the transmission packet through the LSP.

12. A packet processing apparatus located in a Multi Protocol Label Switching-Transport Profile (MPLS-TP) network to transmit packets received from a plurality of networks through a Label Switched Path (LSP), the packet processing apparatus comprising:
a packet classifier configured to classify a received packet to a control packet or a normal packet based on port information included in field information of the received packet, the field information extracted according to control information of a control register, and to decide, if the received packet is a normal packet, a service type for transmitting the normal packet according to whether the normal packet is a reception packet or a transmission packet; and
a packet processor configured to acquire LSP condition information or address information from the field information of the normal packet, and to transmit the received packet and update the header or address information of the received packet, according to the service type decided by the packet classifier, with reference to the LSP condition information or the address information.

13. The packet processing apparatus of claim 12, wherein the packet classifier transmits, if the received packet is a control packet, the control packet to a upper control channel through a CPU interface, and
the packet processor comprises:
a reception packet processor configured to create, if the received packet is a reception packet, a service type related to the reception packet, and to acquire LSP condition information from a table related to the created service type; and
a transmission packet processor configured to acquire, if the received packet is a transmission packet, LSP transmission information or address information for transmitting the transmission packet through the LPS according to whether a destination to which the transmission packet has to be transmitted is a PW end point.

14. The packet processing apparatus of claim 13, wherein the reception packet processor comprises a PW FEC lookup unit configured to combine port information, C-VID information, and S-VID information included in the field information of the reception packet according to the service type decided by the packet classifier and create the decided service type, and to acquire PTL index information and tag control information for extracting LSP information from a PW FEC table.

15. The packet processing apparatus of claim 13, wherein the reception packet processor comprises an IP FEC lookup unit configured to combine port information, C-VID information, a source MAC address, and E-type information included in the field information of the reception packet to create the decided service type, and to acquire PTL index information for extracting LSP information, a control flag for controlling ELSP, and ELSP label information from an IP FEC table database.

16. The packet processing apparatus of claim 13, wherein the reception packet processor comprises a MPLS label lookup unit configured to create the decided service type using port information and MPLS label information included in the field information of the received packet, and to acquire PTL index information for extracting LSP information, a SDT, a new tag, MPLS control information, and tag control information for other control, from a MPLS ILM table database.

17. The packet processing apparatus of claim 14, wherein the reception packet processor comprises:
a first NHLFE lookup unit configured to decide a service type created by at least one lookup unit according to whether information acquired by the corresponding lookup unit is identical to pre-stored information, and to acquire a switch fabric and a transmission/reception output port for transmitting the reception packet through the LSP, a tag value, a TM queue index, a TB profile, a packet counter, and tag control information for other control, from an index table; and
a second NHLFE lookup unit configured to acquire a SLSP label, a plurality of TLSP labels, EXP, Stack, TTL, next PTL index information, D-MAC (Destination-MAC) or M-ID, and label control information, related to a MPLS-TP layer, from a service table.

18. The packet processing apparatus of claim 17, wherein the packet processor further comprises:
a PTL lookup unit configured to acquire token bucket profile information and a token bucket index for policing and shaping to guarantee QoS, from a PTL table database; and
a Hash/TB counter lookup unit configured to decide to transmit the reception packet according to the created service type or a temporary service type stored in a hash table, based on whether the SLSP label acquired by the second NHLFE lookup unit is identical to a SLSP label stored in the service table database,
wherein the Hash/TB counter lookup unit updates, if the SLSP label acquired by the second NHLFE lookup unit is identical to the SLSP label stored in the service table database, a service type stored in the hash table to the created service type, updates, if the SLSP label acquired by the second NHLFE lookup unit is not identical to the SLSP label stored in the service table database, a Hash table database by adding new Hash entries through learning of information acquired from the PTL table database, and decides whether or not to transmit the reception packet in an order of color-marked packets through metering according to whether a bandwidth required by the service type exceeds a threshold value stored in a TB counter table database.

19. The packet processing apparatus of claim 18, wherein the packet processor comprises:
a traffic management unit configured to terminate transmitting the reception packet according to a QoS profile established through the CPU interface from the upper control channel, according to the decision on whether or not to transmit the reception packet by the Hash/TB counter lookup unit;
a header creator configured to create three internal headers based on information acquired by the first and second NHLFE lookup units; and
a header processor configured to perform encapsulation and decapsulation of TLSP and SLSP labels related to the MPLS-TP layer through a Push, Swap, or Pop function, to perform encapsulation of the three internal headers acquired by the header creator, and to insert/remove/change VLAN tag information acquired by the first NHLFE lookup unit into/from/in the field information of the reception packet so that the reception packet is optimized for the destination network, in order to transmit the reception packet through the LSP to a destination network.

20. The packet processing apparatus of claim 19, wherein the packet processor further comprises a TTL controller configured to subtract TTL, if a most significant label (TLSP or SLSP) related to the MPLS-TP layer is Swap, to copy the TTL according to a TTL processing mode if the most significant label is Pop, and to initialize the TTL to a TTL value acquired by the second NHLFE lookup unit if the most significant label is Push, and
the header processor updates a TTL field of the most significant label related to the MPLS-TP layer according to factor values applied by TTL subtraction, TTL copy, and TTL initialization from the TTL controller 538, and inserts/removes/changes the internal headers created by the header creator into/from/in headers of the reception packet, according to header condition information stored in a packet memory.

21. The packet processing apparatus of claim 13, further comprising:
an OAM packet processor configured to determine whether there is an error on a reception path of the classified packet using SLSP OAM, TLSP OAM, and PW OAM stored in an OAM table database; and
a path protection-switching unit configured to perform, if there is an error on the reception path of the packet, protection-switching to a path related to the reception path of the packet.

22. The packet processing apparatus of claim 20, wherein the transmission packet processor comprises:
a port lookup unit configured to update, if the transmission packet is no MPLS transmission packet including the internal headers, a source MAC address of an output port written in field information of the transmission packet, and to acquire the source MAC address, a TM queue index, and packet counter index information of the output port from a S-MAC table database; and
a port label lookup unit configured to update, if the transmission packet is a MPLS transmission packet including the internal headers, the output port written in the field information of the MPLS transmission packet and.
updates source MAC addresses of the output port and the most significant label related to the MPLS-TP layer included in the field information of the transmission packet including internal headers, and acquires a source MAC address, a TM queue index, and packet counter index information of the output port from a port-label table database.

23. The packet processing apparatus of claim 22, wherein the transmission packet processor further comprises a multicast lookup unit configured to decide whether to transmit the transmission packet in a multicast manner or in a unicast manner, based on M-ID information and a flag of at least one label included in the extracted field information, and to acquire a D-MAC address, a PTL index, a MPLS-TP layer label, EXPs, STACKs, TTLs, a tag value, a TM queue index, a counter index, and control information, for transmitting the transmission packet through a LSP established in the MPLS-TP network, from a multicast table database.

24. The packet processing apparatus of claim 23, wherein the transmission packet processor further comprises:
a PW multicast lookup unit configured to decide whether to transmit the transmission packet in a multicast manner or in a unicast manner, based on M-ID information and a flag of at least one label included in the extracted field information, and to acquire a SDT, a PTL index, a tag value, a TM queue index, and control information for transmitting the transmission packet through a LSP established in the MPLS-TP network, from a PW multicast table database; and
a PW decapsulation unit configured to remove PW when a PW terminal flag is enabled.
